(19) United States
(12) Patent Application Publication
(10) Pub. No.: US 2015/0124613 A1
(43) Pub. Date: May 7, 2015

(54) DISTRIBUTED ANCHOR DENB SOLUTION FOR MOBILE RELAY

(71) Applicants: Ling Yu, Oulu (FI); Vinh Van Phan, Oulu (FI); Kari Veikko Horneman, Oulu (FI)

(72) Inventors: Ling Yu, Oulu (FI); Vinh Van Phan, Oulu (FI); Kari Veikko Horneman, Oulu (FI)

(73) Assignee: NOKIA SOLUTIONS AND NETWORKS OY, Espoo (FI)

(21) Appl. No.: 14/397,499

(22) PCT Filed: May 14, 2012
(86) PCT No.: PCT/EP2012/058953

§ 371 Date: Oct. 28, 2014

(30) Foreign Application Priority Data
May 11, 2012 (EP) PCT/EP2012/058838

(51) Int. Cl. H04W 8/18; H04W 64/00; H04L 12/803; H04W 8/02

(52) U.S. Cl. CPC H04W 8/186; H04W 8/02; H04W 64/006; H04L 47/125; H04W 88/005
USPC 370/235; 370/315

(57) ABSTRACT

It is provided an apparatus, comprising storing means adapted to store a group identifier of a cooperative group of one or more network nodes and related one or more node identifiers, wherein each node identifier is related to a network node in the cooperative group; selecting means adapted to select at least one of the network nodes in the cooperative group to provide a gateway function for a relay node upon a request received from the relay node, wherein the request comprises the group identifier of the cooperative group; providing means adapted to provide the respective node identifiers of the at least one selected network node to an access network node for which the providing means is aware that the relay node is connected to the access network node via a radio interface, and to provide an identification of the access network node to each of the at least one selected network node.

### FIELD OF THE INVENTION

The present invention relates to an apparatus, a method, a system, and a computer program product related to (mobile) relay systems. More particularly, the present invention relates to an apparatus, a method, a system, and a computer program product for distributing traffic in a mobile relay system.

### BACKGROUND OF THE INVENTION

### ABBREVIATIONS

3GPP 3^{rd} generation partnership project

BW BandWidth

DeNB Donor eNB

eNB Base station

EPC Enhanced Packet Core

GW Gateway

HO Handover

IP Internet Protocol

LTE Long Term Evolution

LTE-A LTE-advanced

MME Mobility Management Entity

MR Mobile Relay

NGMN Next generation mobile networks

O&M, OAM Operation & Maintenance

P-GW PDN Gateway

PDN Packet Data Network

Rel Release

RN Relay Node

S1 Interface between E-UTRAN and EPC

S-GW Serving Gateway

UE User Equipment

E-UTRAN Evolved Universal Terrestrial RAN

X2 Interface between eNBs

This invention is targeted for 3GPP LTE-A Rel′11 and beyond, addressing the mobile relay (MR) for possible evolution of the fixed relay specified in Rel′10 in order to provide enhanced cellular access and IP services for mobile users aboard of populated public transportation such as passenger trains, ferries or cruise ships.

3GPP is discussing Mobile Relay for Rel-11. Several possible architecture options are proposed in ([1]) and Alt 2 in ([1]) was chosen as fixed relay architecture for Rel-10. Therefore, the proposal “Alt.2” defined in Section 2.2 of ([2]) is advantageous in which it provides full backwards compatibility to Rel-10.

In proposal “Alt.2”, the MR's SGW/PGW resides in the 1st DeNB (“Anchor DeNB”) to which the MR is connected during startup. When the MR is moving away of the Anchor DeNB, it connects to a new serving DeNB. But the MR's traffic (including its own OAM traffic, the 2G/3G/LTE UE's signalling and user traffic) still go back to the Anchor DeNB. This poses a high requirement to the backhaul in the Anchor DeNB, as may be seen from the following example:
Each train has a Mobile Relay (MR).
50 trains start from the central station. Note: A big station has even more trains.
NGMN ([3]) requires 150 Mbps DL and 50 Mbps UL backhaul for a LTE cell using 20 MHz BW carrier
For DL traffic received from UE's SGW, the Anchor DeNB need to transmit it to the MR's serving DeNB. For UL traffic received from the MR's serving DeNB, the Anchor DeNB transmits them to UE's SGW. So for each MR, the Anchor DeNB requires a 200 Mbps (i.e. 150+50) backhaul.

The normal eNB with 3 sectors only requires a 450 Mbps backhaul. In order to support 10 Gbps backhaul for the Anchor DeNB, the operators need to upgrade their transport network, which is not seen desirable. Therefore, the super backhaul problem needs to be solved in order to make “Alt.2” more attractive.

There are several known options to address the super backhaul issue:

When the MR leaves the station, it may detach from the Anchor DeNB, then attach to a new DeNB, thus not requiring the super backhaul for the DeNB at the station. However, there are UEs on the train. When the MR performs detach procedure, the UEs' services are disconnected. This causes a bad “out of service” experience to the UEs.

According to another known option, the operator deploys more DeNBs at the station. For example, the operator deploys 10 DeNB in previous example. Each DeNB requires a 1 GMbps backhaul. But since all 10 DeNBs are installed at the station, this still require the operator to have a 10 Gbps backhaul to the station.

According to another method, additional signalling is required to setup an offload PDN connection in an offload DeNB, switch LTE traffic to the offload DeNB and relocate the Relay-GW to the offload DeNB. When implementation details are taken into account, some additional signalling (e.g. Path Switch Request) is needed for every UE connected to MR, which may introduce significant signalling overhead.

[1] TR 36.806, v9.0.0, “Relay architectures for E-UTRA (LTE-Advanced), March 2010

[2] R3-120423 Offline discussion on mobile relay architecture options

[3] Next Generation Mobile Networks, Optimised Backhaul Requirements, Aug. 14, 2008

### SUMMARY OF THE INVENTION

It is an object of the present invention to improve the prior art.

According to a first aspect of the invention, there is provided an apparatus, comprising requesting means adapted to request a group identifier of a cooperative group of network nodes providing a gateway function for the apparatus from a network control server, wherein the request comprises a selection criterion; indicating means adapted to indicate the group identifier of the selected cooperative group received from the network control server to an access network node or a mobility management entity of the apparatus.

In the apparatus, the selection criterion may comprise at least one of a direction into which the apparatus intends to move, a destination to which the apparatus intends to move, a current area where the apparatus is currently located, and a type of transport means on which the apparatus is installed.

The apparatus may further comprise interfacing means adapted to interface with the access network node via plural interfaces, wherein each of the interfaces is related to a different one of the network nodes of the selected cooperative group; selecting means adapted to select one of the plural interfaces for each user equipment connected to the apparatus; routing means adapted to route a traffic of the user equipment via the selected interface to the access network node.

In the apparatus, the selecting means may be adapted to select the one of the plural interfaces based on a distance to the respective network node of the cooperative group at a time when the user equipment initiates a service request for the traffic.

The apparatus may further comprise relay interfacing means adapted to interface with the access network node via a relay radio interface; UE interfacing means adapted to interface with a user equipment via a UE radio interface; relaying means adapted to relay a traffic of the user equipment between the relay interfacing means and the UE interfacing means.

According to a second aspect of the invention, there is provided an apparatus, comprising requesting processor adapted to request a group identifier of a cooperative group of network nodes providing a gateway function for the apparatus from a network control server, wherein the request comprises a selection criterion; indicating processor adapted to indicate the group identifier of the selected cooperative group received from the network control server to an access network node or a mobility management entity of the apparatus.

In the apparatus, the selection criterion may comprise at least one of a direction into which the apparatus intends to move, a destination to which the apparatus intends to move, a current area where the apparatus is currently located, and a type of transport means on which the apparatus is installed.

The apparatus may further comprise interfacing processor adapted to interface with the access network node via plural interfaces, wherein each of the interfaces is related to a different one of the network nodes of the selected cooperative group; selecting processor adapted to select one of the plural interfaces for each user equipment connected to the apparatus; routing processor adapted to route a traffic of the user equipment via the selected interface to the access network node.

In the apparatus, the selecting processor may be adapted to select the one of the plural interfaces based on a distance to the respective network node of the cooperative group at a time when the user equipment initiates a service request for the traffic.

The apparatus may further comprise relay interfacing processor adapted to interface with the access network node via a relay radio interface; UE interfacing processor adapted to interface with a user equipment via a UE radio interface; relaying processor adapted to relay a traffic of the user equipment between the relay interfacing processor and the UE interfacing processor.

According to a third aspect of the invention, there is provided a relay node comprising an apparatus according to any of the first and second aspects.

According to a fourth aspect of the invention, there is provided an apparatus, comprising storing means adapted to store a group identifier of a cooperative group of one or more network nodes and related one or more node identifiers, wherein each node identifier is related to a network node in the cooperative group; selecting means adapted to select at least one of the network nodes in the cooperative group to provide a gateway function for a relay node upon a request received from the relay node, wherein the request comprises the group identifier of the cooperative group; providing means adapted to provide the respective node identifiers of the at least one selected network node to an access network node for which the providing means is aware that the relay node is connected to the access network node via a radio interface, and to provide an identification of the access network node to each of the at least one selected network node.

In the apparatus, the storing means may be adapted to store plural group identifiers each with related one or more node identifiers, wherein the apparatus may comprise uniqueness caring means adapted to care that each of the plural group identifiers is unique for the apparatus.

The apparatus may further comprise supervising means adapted to supervise at least one of a backhaul capacity and a load condition of at least one network node of the cooperative group, wherein the selecting means may be additionally adapted to select and to deselect one or more of the network nodes in the cooperative group dependent on a result of the supervising by the supervising means.

In the apparatus, the selection means may be adapted to select the at least one of the network nodes based on a receipt time of the request.

According to a fifth aspect of the invention, there is provided an apparatus, comprising storing processor adapted to store a group identifier of a cooperative group of one or more network nodes and related one or more node identifiers, wherein each node identifier is related to a network node in the cooperative group; selecting processor adapted to select at least one of the network nodes in the cooperative group to provide a gateway function for a relay node upon a request received from the relay node, wherein the request comprises the group identifier of the cooperative group; providing processor adapted to provide the respective node identifiers of the at least one selected network node to an access network node for which the providing processor is aware that the relay node is connected to the access network node via a radio interface, and to provide an identification of the access network node to each of the at least one selected network node.

In the apparatus, the storing processor may be adapted to store plural group identifiers each with related one or more node identifiers, wherein the apparatus may comprise uniqueness caring processor adapted to care that each of the plural group identifiers is unique for the apparatus.

The apparatus may further comprise supervising processor adapted to supervise at least one of a backhaul capacity and a load condition of at least one network node of the cooperative group, wherein the selecting processor may be additionally adapted to select and to deselect one or more of the network nodes in the cooperative group dependent on a result of the supervising by the supervising processor.

In the apparatus, the selection processor may be adapted to select the at least one of the network nodes based on a receipt time of the request.

According to a sixth aspect of the invention, there is provided a mobility management entity comprising an apparatus according to any of the fourth and fifth aspects.

According to a seventh aspect of the invention, there is provided an apparatus, comprising storing means adapted to store a group identifier of a cooperative group of network nodes and a related selection criterion; providing means adapted to provide, to a relay node, the group identifier upon a request received from the relay node, wherein the request comprises the selection criterion.

In the apparatus, the selection criterion may comprise at least one of a direction into which the relay node intends to move, a destination to which the relay node intends to move, a current area where the relay node is currently located, and a type of transport means on which the relay node is installed.

In the apparatus, the storing means may be adapted to store plural group identifiers with related selection criteria; the apparatus may further comprise uniqueness caring means adapted to care that each of the plural group identifiers is unique for the apparatus.

According to an eighth aspect of the invention, there is provided an apparatus, comprising storing processor adapted to store a group identifier of a cooperative group of network nodes and a related selection criterion; providing processor adapted to provide, to a relay node, the group identifier upon a request received from the relay node, wherein the request comprises the selection criterion.

In the apparatus, the selection criterion may comprise at least one of a direction into which the relay node intends to move, a destination to which the relay node intends to move, a current area where the relay node is currently located, and a type of transport means on which the relay node is installed.

In the apparatus, the storing processor may be adapted to store plural group identifiers with related selection criteria; the apparatus may further comprise uniqueness caring processor adapted to care that each of the plural group identifiers is unique for the apparatus.

According to a ninth aspect of the invention, there is provided an operation and maintenance center comprising the apparatus according to any of the seventh and eighth aspects.

According to a tenth aspect of the invention, there is provided an apparatus, comprising providing means adapted to provide a gateway function to a traffic received, via a radio interface, from a relay node accessing the apparatus; checking means adapted to check if a gateway network node not comprised by the apparatus is intended to provide the gateway function for the relay node; prohibiting means adapted to prohibit the providing of the gateway function by the providing means if the gateway network node is intended to provide the gateway function.

The apparatus may further comprise routing means adapted to route the traffic of the relay node to the gateway network node.

According to an eleventh aspect of the invention, there is provided an apparatus, comprising providing means adapted to provide a radio access function to a traffic directed to a relay node; checking means adapted to check if an access network node not comprised by the apparatus is intended to provide the radio access function for the relay node; prohibiting means adapted to prohibit the providing of the radio access function by the providing means if the access network node is intended to provide the radio access function.

The apparatus may further comprise routing means adapted to route the traffic directed to the relay node to the access network node.

According to a twelfth aspect of the invention, there is provided an apparatus, comprising providing processor adapted to provide a gateway function to a traffic received, via a radio interface, from a relay node accessing the apparatus; checking processor adapted to check if a gateway network node not comprised by the apparatus is intended to provide the gateway function for the relay node; prohibiting processor adapted to prohibit the providing of the gateway function by the providing processor if the gateway network node is intended to provide the gateway function.

The apparatus may further comprise routing processor adapted to route the traffic of the relay node to the gateway network node.

According to an thirteenth aspect of the invention, there is provided an apparatus, comprising providing processor adapted to provide a radio access function to a traffic directed to a relay node; checking processor adapted to check if an access network node not comprised by the apparatus is intended to provide the radio access function for the relay node; prohibiting processor adapted to prohibit the providing of the radio access function by the providing processor if the access network node is intended to provide the radio access function.

The apparatus may further comprise routing processor adapted to route the traffic directed to the relay node to the access network node.

According to a fourteenth aspect of the invention, there is provided a base station comprising an apparatus according to any of the tenth to thirteenth aspects.

According to a fifteenth aspect of the invention, there is provided a method, comprising requesting a group identifier of a cooperative group of network nodes providing a gateway function for an apparatus performing the method from a network control server, wherein the request comprises a selection criterion; indicating the group identifier of the selected cooperative group received from the network control server to an access network node or a mobility management entity of the apparatus.

In the method, the selection criterion may comprise at least one of a direction into which the apparatus intends to move, a destination to which the apparatus intends to move, a current area where the apparatus is currently located, and a type of transport means on which the apparatus is installed.

The method may further comprise interfacing with the access network node via plural interfaces, wherein each of the interfaces is related to a different one of the network nodes of the selected cooperative group; selecting one of the plural interfaces for each user equipment connected to the apparatus; routing a traffic of the user equipment via the selected interface to the access network node.

The method may further comprise selecting the one of the plural interfaces based on a distance to the respective network node of the cooperative group at a time when the user equipment initiates a service request for the traffic.

The method may further comprise interfacing with the access network node via a relay radio interface; interfacing with a user equipment via a UE radio interface; relaying a traffic of the user equipment between the relay radio interface and the UE radio interface.

According to a sixteenth aspect of the invention, there is provided a method, comprising storing a group identifier of a cooperative group of one or more network nodes and related one or more node identifiers, wherein each node identifier is related to a network node in the cooperative group; selecting at least one of the network nodes in the cooperative group to provide a gateway function for a relay node upon a request received from the relay node, wherein the request comprises the group identifier of the cooperative group; providing the respective node identifiers of the at least one selected network node to an access network node for which it is known that the relay node is connected to the access network node via a radio interface, and to provide an identification of the access network node to each of the at least one selected network node.

The method may further comprise storing plural group identifiers each with related one or more node identifiers, caring that each of the plural group identifiers is unique for an apparatus performing the method.

The method may further comprise supervising at least one of a backhaul capacity and a load condition of at least one network node of the cooperative group, selecting and/or to deselecting one or more of the network nodes in the cooperative group dependent on a result of the supervising.

The method may further comprise selecting the at least one of the network nodes based on a receipt time of the request.

According to a seventeenth aspect of the invention, there is provided a method, comprising storing a group identifier of a cooperative group of network nodes and a related selection criterion; providing, to a relay node, the group identifier upon a request received from the relay node, wherein the request comprises the selection criterion.

In the method, the selection criterion may comprise at least one of a direction into which the relay node intends to move, a destination to which the relay node intends to move, a current area where the relay node is currently located, and a type of transport means on which the relay node is installed.

The method may further comprise storing plural group identifiers with related selection criteria; caring that each of the plural group identifiers is unique for an apparatus performing the method.

According to a eighteenth aspect of the invention, there is provided a method, comprising providing a gateway function to a traffic received, via a radio interface, from a relay node accessing an apparatus performing the method; checking if a gateway network node not comprised by the apparatus is intended to provide the gateway function for the relay node; prohibiting the providing of the gateway function if the gateway network node is intended to provide the gateway function.

The method may further comprise routing the traffic of the relay node to the gateway network node.

According to a nineteenth aspect of the invention, there is provided a method, comprising providing a radio access function to a traffic directed to a relay node; checking if an access network node not comprised by an apparatus performing the method is intended to provide the radio access function for the relay node; prohibiting the providing of the radio access function if the access network node is intended to provide the radio access function.

The method may further comprise routing the traffic directed to the relay node to the access network node.

Each of the methods according to any of the fifteenth to nineteenth aspects may be a method of mobile relaying.

According to a twentieth aspect of the invention, there is provided a computer program product including a program comprising software code portions being arranged, when run on a processor of an apparatus, to perform the method according to any one of the fifteenth to nineteenth aspects.

The computer program product may comprise a computer-readable medium on which the software code portions are stored, and/or the program may be directly loadable into a memory of the processor.

According to embodiments of the invention, at least the following advantages are achieved:

The super backhaul issue is eliminated.

The invention provides a simple but flexible way to utilize a pool of cooperative S-GW/P-GW functions for an MR within the DeNBs cooperative group. This solution reuses the fixed relay architecture specified in 3GPP rel′10, but the radio access part and gateway part of DeNB for MR may be separated into different DeNBs. During MR HO, only the radio part may be handed over from source to target DeNB, whereas the GW part is kept in the same DeNB which may not be the first DeNB that MR is connected to. In this way, the GW function and also the backhaul capability of the DeNBs within the cooperative group can be evenly distributed to the MRs without the need of GW relocation. With the option of multiple mobility anchor points, the optimized route can be achieved for UEs who initiate the service request at different locations during the train journey.

It also provides more robust and efficient solution for fixed relaying.

Unnecessary traffic offloading may be avoided, which improves user experience.

Compared to solutions to the super backhaul issue based on dynamic traffic offloading (e.g. following the handover of the radio part or based on another dynamic criterion), signaling is reduced. In particular, UE related signaling may be avoided.

Also, the flexibility of the operator is improved. He may provide larger backhauls to DeNBs of certain groups only, whereas a standard backhaul is provided to the other DeNBs.

The solution may be transparent to the conventional UEs. Backwards compatibility with re1.10 solution (w/o MR mobility) is achieved to large extend.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows an apparatus according to an embodiment of the invention;

FIG. 2 shows a method according to an embodiment of the invention;

FIG. 3 shows an apparatus according to an embodiment of the invention;

FIG. 4 shows a method according to an embodiment of the invention;

FIG. 5 shows an apparatus according to an embodiment of the invention;

FIG. 6 shows a method according to an embodiment of the invention;

FIG. 7 shows an apparatus according to an embodiment of the invention;

FIG. 8 shows a method according to an embodiment of the invention;

FIG. 9 shows an apparatus according to an embodiment of the invention; and

FIG. 10 shows a method according to an embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

The distributed anchor DeNB solution proposed herein is based on the idea of having more separation between radio access part and relay gateway part in DeNB, as compared to that of Rel′10. According to embodiments of the invention, the relay gateway part of DeNB may be distributed or provided by one or more members of a group of “super-backhaul” interconnected and cooperative DeNBs in such a way that a RN may be connected to a DeNB#A for the radio part, whereas the relay gateway part is provided by a DeNB#B. (DeNB#A and DeNB#B are different members of the configured cooperative DeNB group).

According to some embodiments of the invention, a RN may be served by more than 1 selected DeNBs of the cooperative group for distributed relay gateway functionality if necessary, for instance due to mobility or traffic load of RN (e.g. MR on a long distance train with large number of active users aboard may be served by several DeNBs along the railway track for distributed gateway part).

These connectivity options of relays may be realized using semi-static configuration based on initial DeNB selection or re-selection regarding relay gateway part or anchor DeNB for a fixed or mobile RN, upon initial setup or reactivation (reset). For example, a reset may take place when a train on which the mobile RN is installed starts its route to a certain destination. For another exmaple, a reset may also take place when fixed RN is reactivated due to radio link failure towards previously connected DeNB(s).

According to some embodiments of the invention, the configuration may also be based on more dynamic reconfiguration (including gradual addition/release of selected DeNB(s)).

Such dynamic configuration may take into account e.g. backhaul capacity and/or actual load of one or more of the DeNBs of the cooperative group.

The above method may enable sufficient Rel′10 backward-compatible supports of both fixed and mobile relays.

In the following some particular aspects according to some embodiments of the invention are described:

The cooperative group of DeNBs (e.g. the DeNBs along a certain railway track) is formed and configured to provide a collective pool for MR's S-GW/P-GW functions that are embedded in DeNBs as defined in fixed relay architecture in 3GPP rel′10. One DeNB may belong to different cooperative groups, and each cooperative group is identified by a unique identifier. For example, the DeNB that serves the central railway station in Paris may belong to multiple cooperative groups and each group may consist of the DeNBs along the railway track to a certain direction. The cooperative group may be statically or semi-statically configured by eNB's O&M and may be indicated to relevant MMEs and/or DeNBs and/or MR's O&M.

MRs startup or reset procedure may be split into two phases:

During phase I of MR startup/reset procedure, MR may indicate the destination information to MR's O&M as user plane traffic. Based on the destination indication, MR's O&M may determine the DeNBs cooperative group which can serve the MR and then provide the identifier of the cooperative group as MR pre-configuration parameter. Instead of the destination information, other selection criteria may be chosen such as a direction into which the relay node intends to move, a current area where the relay node is currently located, and a type of transport means (e.g. long distance train or local train, cruise ship etc., number of seats in the train/ship etc.) on which the relay node is installed. Instead of the MR's O&M another suitable control system may take the role of the O&M.

During phase II of the MR startup/reset procedure, the cooperative group identifier retrieved from MR's O&M during phase I may be indicated to MME instead of the IP address of the S-GW/P-GW function embedded in the DeNB that MR is currently connected to. In addition, MR indication is also included in the same message. Based on MR indication and cooperative group identifier MME may then determine to select one or multiple DeNBs in the cooperative group to act as the mobility anchor(s) for the MR so that the S-GW/P-GW function embedded in the selected DeNB(s), instead of MR connected DeNB, provides the S1/X2 proxy function for the MR. Additionally, the DeNB selection may take into account one or more of different aspects such as configuration and status information of the DeNBs in the group (e.g. the backhaul capacity of each DeNB, the load condition of each DeNB including the normal UE traffic and also MR traffic), and even the timing of the MR startup (e.g. for the MR installed on night train, the DeNB(s) that is far away from current connected DeNB may be selected since the UEs on the train may most probably become active during the daytime when the train is closer to the destination). MME informs the MR connected DeNB and the selected DeNBs that provides S-GW/P-GWs about the respective other network node(s). Therein, DeNB is aware of the identity of the MR, e.g. based on the established control plane connection, for which the selection was made.

In case that multiple DeNBs are selected to provide S1/X2 proxy function for the MR (e.g. by the MME or O&M), multiple S1/X2 connections are setup for the MR and each connection corresponds to one selected DeNBs. In this case, those selected DeNBs appear as multiple MMEs and S-GWs/P-GWs (which may be located in different areas along the railway track) connected to the MR. Thus, the MR is aware of the multiple selected S-GWs/P-GWs. For each UE on board, MR may select one of the DeNBs to provide S1/X2 proxy function, e.g. the one that is closest to the location of the MR when an UE initiates a service request (e.g. the one to which the MR is connected via the radio interface). To achieve this, the MR may be pre-configured, either by MME or O&M, with all the necessary information of the DeNBs in the cooperative group to faciliate the MR to do the selection. For example, the service area of the gateway function in each selected DeNBs and also the respective S1/X2 connection may be configured to the MR. Based on the MR's location, the MR may select the S1/X2 connection that is connected to the DeNB who serve the MR's current location as the gateway.

Embodiments of the invention may also be applied to fixed relay in such way that the cooperative group is formed by the DeNBs that have direct X2 connection. During RN startup or reset, the S-GW/P-GW function of any DeNB in the cooperative group may be selected to provide S1/X2 proxy function so that the radio access part and relay gateway part of DeNB may be separated into the different DeNB for the RN.

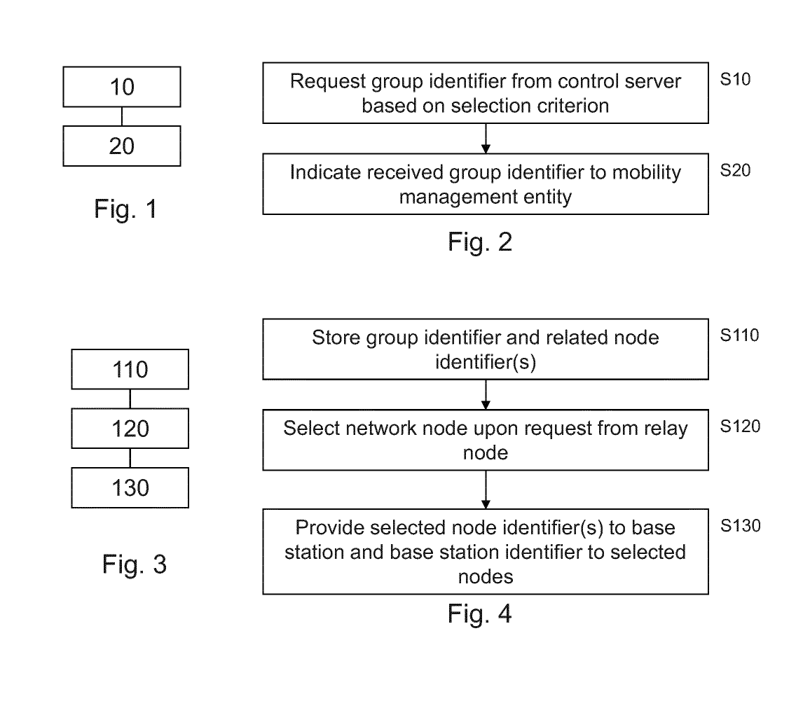

FIG. 1 shows an apparatus according to an embodiment of the invention. The apparatus may be a relay node such as a mobile relay node. FIG. 2 shows a method according to an embodiment of the invention. The apparatus according to FIG. 1 may perform the method of FIG. 2 but is not limited to this method. The method of FIG. 2 may be performed by the apparatus of FIG. 1 but is not limited to being performed by this apparatus.

The apparatus comprises requesting means 10 and indicating means 20.

The requesting means 10 requests a group identifier from a network control server such as an operation and management system (S10). The request comprises a selection criterion such as a destination of the train (ship), a type of train etc.

After the group identifier is received from the control server, the indicating means 20 indicates the group identifier to a mobility management entity (or a serving network node) of the apparatus (S20). The control server may be different from the mobility management entity and the serving network node.

FIG. 3 shows an apparatus according to an embodiment of the invention. The apparatus may be a mobility management entity. FIG. 4 shows a method according to an embodiment of the invention. The apparatus according to FIG. 3 may perform the method of FIG. 4 but is not limited to this method. The method of FIG. 3 may be performed by the apparatus of FIG. 4 but is not limited to being performed by this apparatus.

The apparatus comprises storing means 110, selecting means 120, and providing means 130.

The storing means 110 stores a group identifier of a cooperative group and related one or more node identifiers such as IP addresses. Each node identifier is related to a serving gateway/packet data gateway of a donor base station of the cooperative group (S110). If the storing means stores several group identifiers, each of them may be unique for the apparatus. In addition, the storing means 110 may store e.g. some GTP protocol parameters.

If a request comprising a group identifier is received from a relay node, the selecting means 120 selects a network node of the cooperative group based on the received group identifier (S120).

The providing means 130 provides the node identifier(s) of the selected network nodes to an access network node to which the relay node is connected via a radio interface. In addition, it provides an identification of the access network node to the selected network nodes (S130). The access network node may be a base station such as a DeNB.

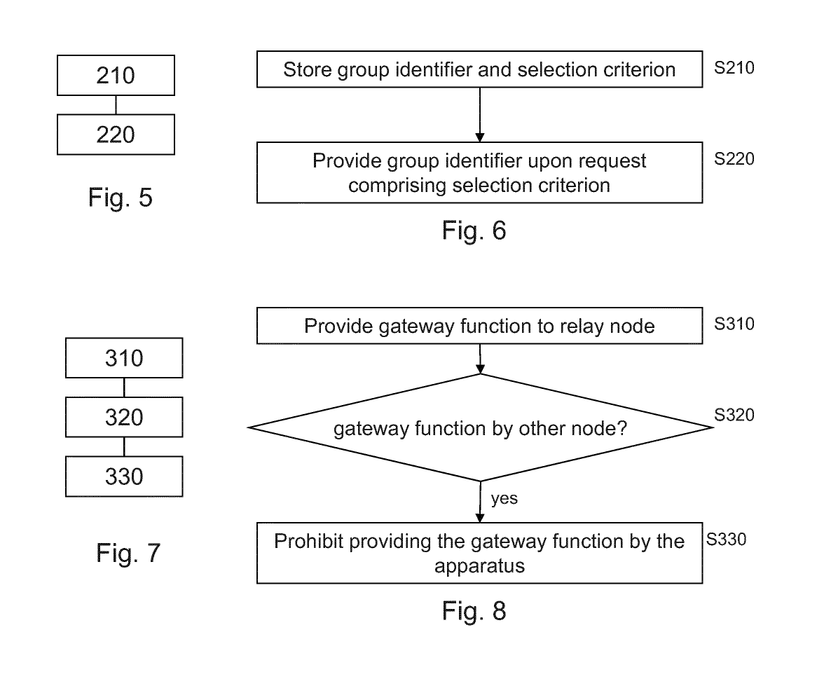

FIG. 5 shows an apparatus according to an embodiment of the invention. The apparatus may be a control system such as an operation and maintenance center. FIG. 6 shows a method according to an embodiment of the invention. The apparatus according to FIG. 5 may perform the method of FIG. 6 but is not limited to this method. The method of FIG. 5 may be performed by the apparatus of FIG. 6 but is not limited to being performed by this apparatus.

The apparatus comprises storing means 210, and providing means 220.

The storing means 210 stores a group identifier and a related selection criterion (S210). Several selection criteria may be related to a group identifier. If several group identifiers are stored, each group identifier may be unique for the apparatus.

If a request comprising one of the selection criteria is received from the relay node, the providing means 220 provides the corresponding group identifier to the relay node (S220).

FIG. 7 shows an apparatus according to an embodiment of the invention. The apparatus may be a base station such as a DeNB. FIG. 8 shows a method according to an embodiment of the invention. The apparatus according to FIG. 7 may perform the method of FIG. 8 but is not limited to this method. The method of FIG. 7 may be performed by the apparatus of FIG. 8 but is not limited to being performed by this apparatus.

The apparatus comprises providing means 310, checking means 320, and prohibiting means 330.

The providing means 310 provides a gateway function to traffic received from a relay node via a radio interface (S310). That is, the relay node is served by the apparatus.

The checking means 320 checks if it is intended that another gateway network node not comprised in the apparatus provides the gateway function to the relay node (S320). If this check is positive, the prohibiting means 330 prohibits that the providing means provides the the gateway function (S330). Instead, in some embodiments, a routing means may route the traffic to the other gateway network node.

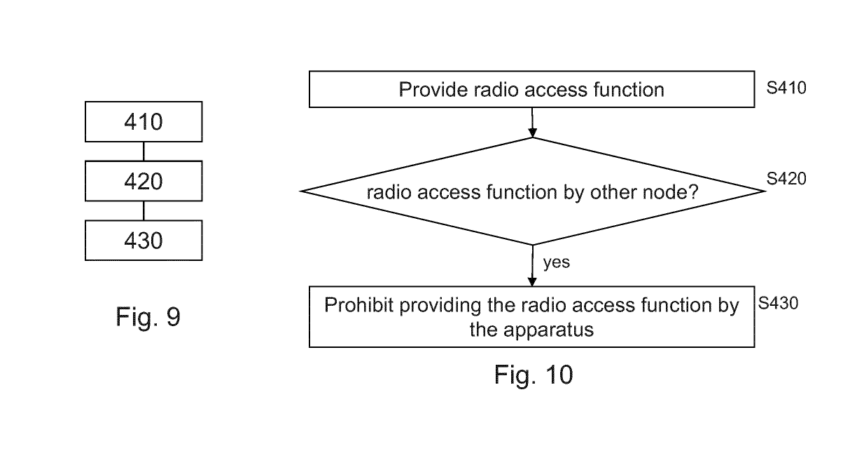

FIG. 9 shows an apparatus according to an embodiment of the invention. The apparatus may be a base station such as a DeNB. FIG. 10 shows a method according to an embodiment of the invention. The apparatus according to FIG. 9 may perform the method of FIG. 10 but is not limited to this method. The method of FIG. 9 may be performed by the apparatus of FIG. 10 but is not limited to being performed by this apparatus.

The apparatus comprises providing means 410, checking means 420, and prohibiting means 430.

The providing means 410 provides a radio access function to traffic directed to a relay node (S410).

The checking means 420 checks if it is intended that another gateway network node not comprised in the apparatus provides the radio access function for the traffic to the relay node (S420). If this check is positive, the prohibiting means 430 prohibits that the providing means provides the radio access function (S430). Instead, in some embodiments, a routing means may route the traffic to the other access network node.

Embodiments of the invention are described based on an LTE-A system but embodiments of the invention may be applied to LTE, UMTS or any other radio access network (e.g. GERAN, EDGE) where (mobile) relay nodes may be employed.

A user equipment may be any kind of a terminal, such as a mobile phone, a laptop, a PDA, a smartphone, etc., which may be connected to the network via the corresponding radio interface.

If not otherwise stated or otherwise made clear from the context, the statement that two entities are different means that they are differently addressed in the mobile network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a relay node such as a mobile relay node, or a component thereof, an apparatus embodying the same, a method for controlling and/or operating the same, and computer program(s) controlling and/or operating the same as well as mediums carrying such computer program(s) and forming computer program product(s). Furthermore, according to the above description, it should thus be apparent that exemplary embodiments of the present invention provide, for example a management entity such as a mobility management entity, or a component thereof, an apparatus embodying the same, a method for controlling and/or operating the same, and computer program(s) controlling and/or operating the same as well as mediums carrying such computer program(s) and forming computer program product(s). Furthermore, according to the above description, it should thus be apparent that exemplary embodiments of the present invention provide, for example a operation center such as an operation and maintenance center, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1. An apparatus, comprising:
requesting means for requesting a group identifier of a cooperative group of network nodes providing a gateway function for the apparatus from a network control server, wherein the request comprises a selection criterion;
indicating means for indicating the group identifier of the selected cooperative group to an access network node or a mobility management entity of the apparatus.

2. The apparatus according to claim 1, wherein the selection criterion comprises at least one of a direction into which the apparatus intends to move, a destination to which the apparatus intends to move, a current area where the apparatus is currently located, and a type of transport means on which the apparatus is installed.

3. The apparatus according to claim 1, further comprising:
interfacing means for interfacing with the access network node via plural interfaces, wherein each of the interfaces is related to a different one of the network nodes of the selected cooperative group;
selecting means for selecting one of the plural interfaces for each user equipment connected to the apparatus;
routing means for routing a traffic of the user equipment via the selected interface to the access network node.

4. The apparatus according to claim 3, wherein
the selecting means is for selecting the one of the plural interfaces based on a distance to the respective network node of the cooperative group at a time when the user equipment initiates a service request for the traffic.

5. The apparatus according to claim 1, further comprising:
relay interfacing means for interfacing with the access network node via a relay radio interface;
UE interfacing means for interfacing with a user equipment via a UE radio interface;
relaying means for relaying a traffic of the user equipment between the relay interfacing means and the UE interfacing means.

6. Relay node comprising an apparatus according to claim 1.

7. An apparatus, comprising:
storing means for storing a group identifier of a cooperative group of one or more network nodes and related one or more node identifiers, wherein each node identifier is related to a network node in the cooperative group;
selecting means for selecting at least one of the network nodes in the cooperative group to provide a gateway function for the relay;
providing means for providing the respective node identifiers of the at least one selected network node to an access network node for which the providing means is aware that the relay node is connected to the access network node via a radio interface, and to provide an identification of the access network node to each of the at least one selected network node.

8. The apparatus according to claim 7, wherein
the storing means is also for storing plural group identifiers each with related one or more node identifiers, wherein the apparatus comprises
uniqueness caring means for caring that each of the plural group identifiers is unique for the apparatus.

9. The apparatus according to claim 7, further comprising:
supervising means for supervising at least one of a backhaul capacity and a load condition of at least one network node of the cooperative group, wherein
the selecting means is additionally for selecting and for deselecting one or more of the network nodes in the cooperative group dependent on a result of the supervising by the supervising means.

10. The apparatus according to claim 7, wherein
the selection means is also for selecting the at least one of the network nodes based on a receipt time of the request.

11. A mobility management entity comprising an apparatus according to claim 7.

12. An apparatus, comprising:
storing means for storing a group identifier of a cooperative group of network nodes and a related selection criterion;
providing means for providing, to the relay node, the group identifier.

13. The apparatus according to claim 12, wherein the selection criterion comprises at least one of a direction into which the relay node intends to move, a destination to which the relay node intends to move, a current area where the relay node is currently located, and a type of transport means on which the relay node is installed.

14. The apparatus according to claim 12, wherein
the storing means is also for storing plural group identifiers with related selection criteria; the apparatus further comprising
uniqueness caring means for caring that each of the plural group identifiers is unique for the apparatus.

15. An operation and maintenance center comprising the apparatus according to claim 12.

16.-20. (canceled)

21. A method, comprising
requesting a group identifier of a cooperative group of network nodes providing a gateway function for an apparatus performing the method from a network control server, wherein the request comprises a selection criterion;
receiving a group identifier of a selected cooperative group from the network control server;
indicating the group identifier of the selected cooperative group to an access network node or a mobility management entity of the apparatus.

22. The method according to claim 21, wherein the selection criterion comprises at least one of a direction into which the apparatus intends to move, a destination to which the apparatus intends to move, a current area where the apparatus is currently located, and a type of transport means on which the apparatus is installed.

23. The method according to claim 21, further comprising:
interfacing with the access network node via plural interfaces, wherein each of the interfaces is related to a different one of the network nodes of the selected cooperative group;
selecting one of the plural interfaces for each user equipment connected to the apparatus;
routing a traffic of the user equipment via the selected interface to the access network node.

24. The method according to claim 23, further comprising
selecting the one of the plural interfaces based on a distance to the respective network node of the cooperative group at a time when the user equipment initiates a service request for the traffic.

25. The method according to claim 21, further comprising
interfacing with the access network node via a relay radio interface;
interfacing with a user equipment via a UE radio interface;
relaying a traffic of the user equipment between the relay radio interface and the UE radio interface.

26. A method, comprising
storing a group identifier of a cooperative group of one or more network nodes and related one or more node identifiers, wherein each node identifier is related to a network node in the cooperative group;
receiving a request from a relay node, wherein the request comprises the group identifier of the cooperative group;
selecting at least one of the network nodes in the cooperative group to provide a gateway function for a relay node;
providing the respective node identifiers of the at least one selected network node to an access network node for which it is known that the relay node is connected to the access network node via a radio interface, and to provide an identification of the access network node to each of the at least one selected network node.

27. The method according to claim 26, further comprising
storing plural group identifiers each with related one or more node identifiers, caring that each of the plural group identifiers is unique for an apparatus performing the method.

28. The method according to claim 26, further comprising
supervising at least one of a backhaul capacity and a load condition of at least one network node of the cooperative group, and
selecting or deselecting one or more of the network nodes in the cooperative group dependent on a result of the supervising.

29. The method according to claim 26, further comprising
selecting the at least one of the network nodes based on a receipt time of the request.

30. A method, comprising:
storing a group identifier of a cooperative group of network nodes and a related selection criterion;
receiving a request from a relay node, wherein the request comprises the selection criterion; and
providing, to athe relay node, the group identifier.

31. The method according to claim 30, wherein the selection criterion comprises at least one of a direction into which the relay node intends to move, a destination to which the relay node intends to move, a current area where the relay node is currently located, and a type of transport means on which the relay node is installed.

32. The method according to claim 30, further comprising;
storing plural group identifiers with related selection criteria; and
caring that each of the plural group identifiers is unique for an apparatus performing the method.

33.-38. (canceled)
